(19) United States
(12) Patent Application Publication
(10) Pub. No.: US 2007/0183408 A1
(43) Pub. Date: Aug. 9, 2007

(54) MOBILE NETWORK, STATION, SERVER AND METHOD FOR ASSIGNING TO A MOBILE STATION A FIXED AND PUBLIC IP ADDRESS

(76) Inventors: Christopher G. Lowery, Verbier (CH); Karl Ahmed, South Bucks (GB)

Correspondence Address: GAUTHIER & CONNORS, LLP, 225 FRANKLIN STREET, SUITE 2300, BOSTON, MA, 02110, US

(21) Appl. No.: 11/559,590

(22) Filed: Nov. 14, 2006

Related U.S. Application Data
(63) Continuation of application No. PCT/SE05/00710, filed on May 16, 2005.

(30) Foreign Application Priority Data
May 14, 2004 (SE) 0401266-2

(51) Int. Cl. H04L 12/66

(52) U.S. Cl. 370/352

(57) ABSTRACT

The present invention relates to a mobile communications network comprising package switched communication ability, the network comprising: one or several mobile stations, a service provider, providing communication with said mobile stations, a user, communicating with said mobile stations, wherein the mobile communications network is arranged to assign said mobile stations with a fixed Internet Protocol (IP) address by means of a server, which is arranged to map a (private) network IP address seamlessly to the public IP address.

### TECHNICAL FIELD OF THE INVENTION

The present invention relates to a communications network, especially a mobile communications system, and in particular a package switched network, such as a GPRS based communications network.

### BACKGROUND OF THE INVENTION

The number of users of mobile networks and services is increasing rapidly. The services provided by the network operators and other service provides calls for better, faster and more reliable handling of calls, both voice and data.

Around the corner is the 3^{rd} generation's communications network, which is faster than today's 2^{nd} generation communications network, e.g. GSM. Nevertheless, the costly expansion of the infrastructure for the 3^{rd} generation mobile system grows slowly, while the full power of the 2^{nd} generation mobile system is not fully exploited. General Packet Radio Service (GPRS), for example, allows faster package switched communication over a 2^{nd} generation communication network.

WO 02/47353 relates to a method for improving monitoring measures in telecommunications networks and data networks (typically IP-based networks with internet and intranet connection). Improved technological developments have resulted in the provision of packet-oriented mobile radio networks (GSM/GPRS, UMTS etc.) as well as in improved Internet access over a fixed network, which offers cost-optimized Internet access for flat rate or always-on traffic. Due to the fact that no public internet addresses are sufficiently available, public internet addresses have to be duplicated via port sharing (PAT), timesharing (NAT), applications sharing (proxy) or by other methods. When transforming an address at the network boundary, this information, however, is not available inside the network-internal communications protocol so that monitoring measures can only be implemented in a limited manner over network boundaries. The invention eliminates this problem by virtue of the fact that the converting devices are integrated in the monitoring measure via technical implementations that are used as desired, whereby the main focus of consideration is on a solution which is cost-effective and safeguards performance.

A method and system for supporting Internet Protocol (IP) services initiated through a public network are disclosed in WO 02/077842. The services directed are to a mobile device through a private network. In operation following steps occur: assigning a long lived IP address and user name to the mobile in a wireless network; providing a server including a database that cross references the user name and long lived IP address; connecting an address space for the private network to the public network using network address translator (NAT); initiating a push session between a push client and the mobile by forwarding from the push client to the server the user name; retrieving and returning to the NAT the long lived IP address corresponding to the user name; and assigning a corresponding dynamic public address, using an ALG that is associated with the NAT and returning the dynamic public address to the push client.

### SUMMARY OF THE INVENTION

What is needed is a mobile communication network, with ability of migrating existing services and connectivity to dedicated package based networks, such as GPRS networks.

Moreover, the invention provides for:
Operator independent services,
Secure, high speed and flexible wireless network,
Fully redundant network architecture,
Equipment hosted and maintained to carrier grade, with SLA's to approved standards,
Accessible from wide range of locations around the world,
Higher data rate than standard GPRS,
Less congested network using dedicated APN,
Adaptability for future standards, such as EDGE, UMTS, etc.
Ability for all devices linked to the network to communicate with each other, through Device to Device connectivity using Fixed IP addresses,
Ability of all devices to initiate transmission or to request other devices to initiate transmission, as each device has a fixed IP, and thus the address is known always,
Ability to control physical location of all devices from their GPRS position, e.g. using triangulation which can locate geographically the device,
Ability to manage all devices individually from a web based management display. A back office function allows 3^{rd} parties to switch on/off and monitor traffic through the network.
Ability to permit authorised persons to access the management display via a secure site address on the Public Internet.
Grouping of batches of IP addresses securely ring-fenced to prevent access to device information by other users of the network. This can be done by pre-allocating the addresses and provide ranges that do not conflict or come from the same group.
Accelerated transmission of data for all applications, including e-mail, web browsing and any large data transfers.
Selective decompression of large data transfers, photos etc., by the user for increased resolution when desired.

For these reasons, a mobile communications network is provided comprising package switched communication ability, the network comprising: one or several mobile stations, a service provider, providing communication with said mobile stations, a user, communicating with said mobile stations, wherein the mobile communications network is arranged to assign said mobile stations with a fixed Internet Protocol (IP) address by means of a server, which is arranged to map a (private) network IP address seamlessly to the public IP address.

Preferably, said IP address is connected to a unique identity of said mobile station. The unique identity may be International Mobile Equipment Identity (IMEI) number of said mobile station. Moreover, the mobile station may comprise a SIM card provided instructions for accelerated communication.

The invention also relates to a mobile station, for use in the aforementioned network. The mobile station comprises package switched communication ability to communicate with the said network, comprising: at least one unique identity arrangement, at least one encryption arrangement, at least one GPRS modem device. The mobile station further comprises means for receiving a fixed Internet Protocol (IP) address, which is mapped from a (private) network IP address seamlessly to the public IP address. The unique identity arrangement is a SIM card or an identity chip. The IP address can be used and connected to a unique identity provided by the network. The unique identity can be International Mobile Equipment Identity (IMEI) number of said mobile station and is used to identify the mobile station.

The invention also relates to a server for use in the aforementioned network. The server comprises a package operating system and hardware, means for storing information about the network and mobile station, said server comprising: instruction set to control data and communication parameters, instruction set encryption/decryption of data, instruction set for compression/decompression of data. The server is arranged to provide access to information about the network and base station. The network IP address is mapped seamlessly to a public IP address. The mapping can be done using a proxy server. The server may be part of the network arranged as a gateway to additional connectivity.

The invention also relates to a method for providing package switched communication ability in a mobile communications network. The method comprises the steps of: arranging one or several mobile stations, through a service provider, providing communication with said mobile stations, allowing a user to communicate with said mobile stations, and arranging the mobile communications network to assign said mobile stations with a fixed Internet Protocol (IP) address.

### BRIEF DESCRIPTION OF THE DRAWINGS

In the following, the invention will be further described in a non-limiting way with reference to the accompanying drawings in which:

FIG. 1 schematically illustrates a mobile communication network according to the present invention,

FIG. 2 is a schematic illustration of a mobile station according to the present invention, and

FIG. 3 is a general block diagram of the invention.

### DETAILED DESCRIPTION OF THE EMBODIMENTS

Briefly, the invention relates to the ability to ‘interlace’ the systems seamlessly, the system comprises:
At least one (standard) GPRS network, which can be provided by any mobile operator,
At least one (standard) GPRS modem engine, which can be provided by any manufacturer.

One basic gap in the existing GPRS offers ability in the Internet domain to provide the Fixed IP address. Thus, there is a desire to bring and align the disparity between the Internet and wireless domains.

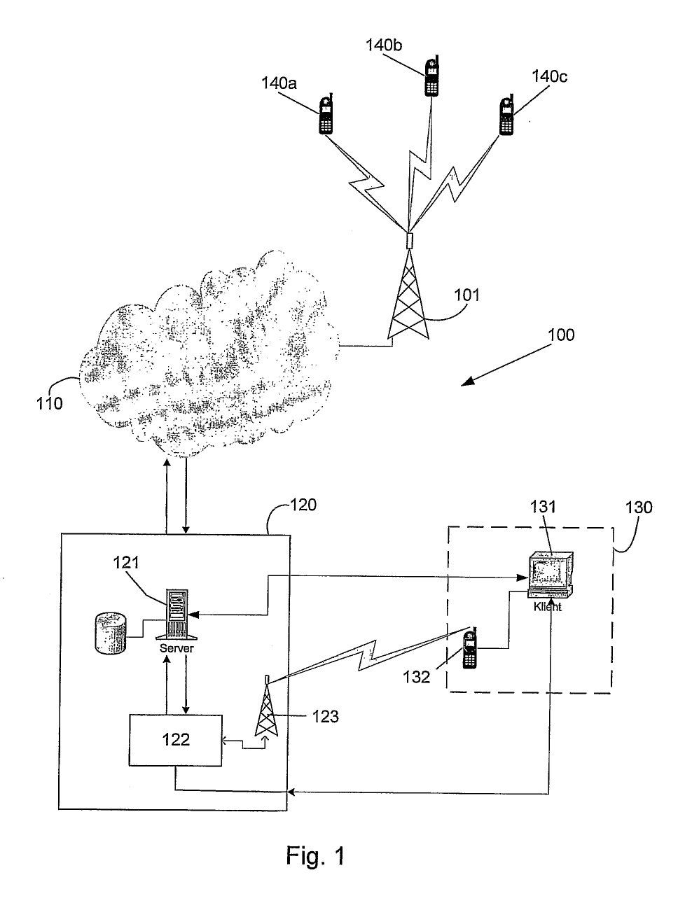

FIG. 1 illustrates a communications network 100 according to the invention. The communications network 100 comprises an operator network 110, a service provider 120, a client site 130 and a number of mobile stations 140a-140c.

The operator network 110 may be any of a mobile or cellular communications network such as GSM, Universal Mobile Telecommunications System (UMTS) or Enhanced Data GSM Environment (EDGE). The operator network allows package-based communication.

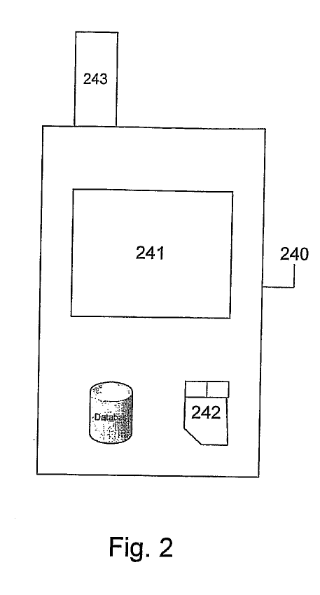

The mobile stations 140a-140c may comprise any type of communication device adapted for communication with the operator's network. Thus, a mobile station may comprise a cellular phone, transceiver, transmitter, etc. Each mobile station 240, as illustrated in FIG. 2, comprises a SIM card 242, a communication part 241, and an antenna 243. The SIM card is a modified card according to the invention and includes instruction set for compression, encrypted communication and also the fixed IP address. The compression provides accelerated data communication. The encryption and compression

The mobile stations can be used as a mobile phone or as transmitter/receiver attached to monitoring devices, such as for fire detectors, alarms, controllers, measuring units, etc.

Each mobile station is provided with a fixed IP address. The IP-address is connected to a unique identity of the mobile station, e.g. International Mobile Equipment Identity (IMEI) number or a hardware identity of the mobile station. IMEI is a unique number given to every single mobile station. IMEI numbers of cellular phones connected to a network are stored in a database (EIR—Equipment Identity Register) containing all valid mobile phone equipment. This may also be extended to the location of the device, usage information, access and protocol details. The assigned fixed IP address allows faster information exchange with the mobile stations directly and without a need for initial handshake.

Moreover, the mobile station comprises package switched communication ability to communicate with the network, and further comprises: a SIM card or identity chip, encryption software or chip and a GPRS modem or chip. The mobile station is arranged to provide a fixed Internet Protocol (IP) address.

The service provider site 120 comprises a server 121 (or several) for running applications, such as FTP server, Radius server, encryption/decryption, compression etc. The server also keeps track of assigned fixed IP addresses to the mobile stations, as mentioned above. The site also includes gateways 122 and controlling devices for connecting to the wireless mobile network and corresponding antenna.

According to one preferred embodiment a device is used for connecting a number of incoming analogous and/or digital data inputs to a package switched output, specially a General Packet Radio Service (GPRS) based output. The device comprises:
at least one analogous and/or digital data interface for interfacing said inputs,
a SIM card,
an instruction set memory,
a wireless transceiver,
means for converting input data to GPRS data,
means for encrypting output data, and
means for compressing data.

The server comprises package operating system and standard hardware, the ability to store information about the network and mobile station. The server further comprises: a dedicated and specially instruction set package to control the data and communication parameters, a server based software for the decryption algorithms, one server based software for the decompression algorithms. Moreover, the server is arranged to control and interface to a 3^{rd} party to provide access to information about the network and base station. The server maps a (private) network IP address seamlessly to the public IP address. Mapping the IP address to Public IP is done using a proxy server. Thus, the invention differs from the above mentioned prior art, which dynamic assigns public addresses that correspond to a ling lived IP address and returns the dynamic public address to a push client.

The server is part of the network and is the gateway to 3^{rd} party connectivity.

The client site 130 may include computer units 131, e.g. for sending, receiving and monitoring the mobile stations. The computer unit connects to the service provider site directly through, e.g. PSTN, through the server 121, through a WEB site at the service provider site, through controlling unit 122 or wirelessly through a gateway 132, e.g. using GPRS.

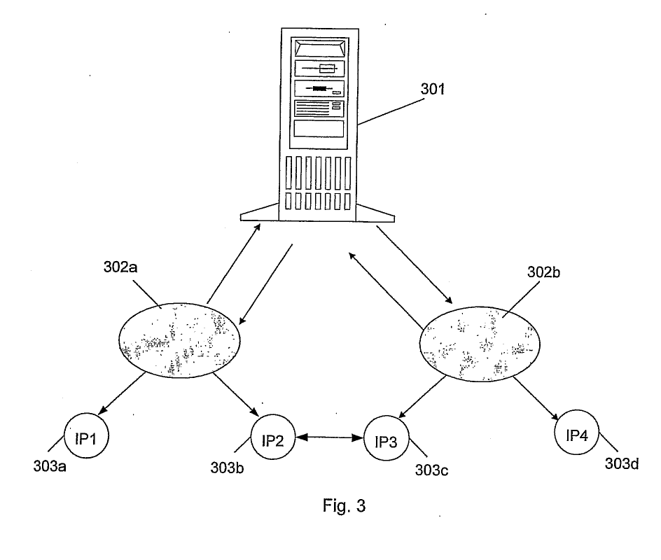

Fig. 3 is a block diagram illustrating one aspect of the invention, in which a central server 301 is arranged to allocate IP addresses and mediate peer-to-peer connections, the IP addresses are provided to base stations 302a and 302b. The base stations transfer the IP addresses to clients (mobile stations) 303a-303d, each being provided with a unique IP address IP1-IP4. IP addressing is static and when received by the clients, they can connect directly (through the network).

The invention is not limited to the shown embodiments but can be varied in a number of ways without departing from the scope of the appended claims and the arrangement and the method can be implemented in various ways depending on application, functional units, needs and requirements etc.

1. A mobile communications network comprising package switched communication ability, the network comprising:
one or several mobile stations,
a service provider, providing communication with said mobile stations,
a user, communicating with said mobile stations,
wherein the mobile communications network is arranged to assign said mobile stations with a fixed Internet Protocol (IP) address by means of a server, which is arranged to map a (private) network IP address seamlessly to the public IP address.

2. The network of claim 1, wherein said IP address is connected to a unique identity of said mobile station.

3. The network of claim 2, wherein said unique identity is International Mobile Equipment Identity (IMEI) number of said mobile station.

4. The network of claim 1, wherein said mobile station comprises a SIM card provided instructions for accelerated communication.

5. A mobile station for use in a network according to claim 1, said mobile station comprising package switched communication ability to communicate with the said network, comprising:
at least one unique identity arrangement,
at least one encryption arrangement,
at least one GPRS modem device,
characterised in that said mobile station further comprises means for receiving a fixed Internet Protocol (IP) address, which is mapped from a (private) network IP address seamlessly to the public IP address.

6. The mobile station of claim 5, wherein said unique identity arrangement is a SIM card.

7. The mobile station of claim 5, wherein said unique identity arrangement is an identity chip

8. The mobile station of claim 5, wherein said IP address is used and connected to a unique identity provided by the network.

9. The mobile station of claim 5, wherein said unique identity is International Mobile Equipment Identity (IMEI) number of said mobile station and is used to identify the mobile station.

10. A server for use in a network according to claim 1, the server comprising a package operating system and hardware, means for storing information about the network and mobile station, said server comprising:
instruction set to control data and communication parameters,
instruction set encryption/decryption of data,
instruction set for compression/decompression of data,
Wherein said server is arranged to provide access to information about the network and base station and map a (private) network IP address seamlessly to the public IP address.

11. The server of claim 10, wherein said mapping is done using a proxy server.

12. The server of claim 11, wherein said server is part of the network arranged as a gateway to additional connectivity.

13. A method for providing package switched communication ability in a mobile communications network, the method comprising the steps of:
arranging one or several mobile stations,
providing communication with said mobile stations through a service provider,
allowing a user to communicate with said mobile stations,
arranging the mobile communications network to assign said mobile stations with a fixed Internet Protocol (IP) address, which is mapped from a (private) network IP address seamlessly to the public IP address
